(19) United States
(12) Patent Application Publication
(10) Pub. No.: US 2016/0180203 A1
(43) Pub. Date: Jun. 23, 2016

(54) Protection of Communication Lines

(71) Applicants: David SORIANO FOSAS, Barcelona (ES); Jose Ma RIO DUVAL, Barcelona (ES); Javier GONZALES BRUNO, Barcelona (ES)

(72) Inventors: David Soriano Fosas, Barcelona (ES); Jose Ma Rio Doval, Sant Cugat del Valles (ES); Javier Gonzalez Bruno, Terrassa (ES)

(73) Assignee: HEWLETT-PACKARD DEVELOPMENT COMPANY, L.P., Houston, TX (US)

(21) Appl. No.: 14/909,685

(22) PCT Filed: Aug. 13, 2013
(86) PCT No.: PCT/EP2013/066911

§ 371 Date: Feb. 2, 2016

(51) Int. Cl. G06K 15/00

(52) U.S. Cl. CPC G06K 15/4045

(57) ABSTRACT

Protection of communication lines are described herein. In at least some examples herein, a communication line interfaces an emitter terminal. A controllably conductive device has a first main load terminal, a second main load terminal, and a control input. The controllably conductive device is connected in series along the communication line. The first main load terminal is connected to the emitter terminal, the second main load terminal is connected to the output terminal. A reference voltage terminal is connected to the control input via a control resistor.

### BACKGROUND

Communication lines for communication have become nowadays ubiquitous. Some prominent examples are low-voltage differential signaling (LVDS), universal serial bus (USB), peripheral component interconnect (PCI), or high-definition multimedia interface. One of most desired requisites on communication lines is allowing high speed communication, for example communication above 10 MByte/second. Communication lines provide a solution to a variety of interfaces requiring high speed communication. One example of such interfaces is the communication line between a printer and a printhead.

Generally, a communication line interfaces a data generation circuit (e.g., a printer circuit that generates signals for operating a printhead) with an output (e.g., the interface of a printhead). If the communication line is subjected to a short circuit, the integrity of the data generation circuit might become compromised. In some short circuit events, the data generation circuit might become even irreparably damaged.

### BRIEF DESCRIPTION OF THE DRAWINGS

In order that the present disclosure may be well understood, various examples will now be described wilh reference to the following drawings.

FIG. 1 illustrates systems for protection of communication lines according to examples.

FIGS. 2A and 2B illustrate systems for protection of communication lines during operation according to examples.

FIG. 3 illustrates implementation of a protection system for protecting a differential communication line according to examples herein.

FIG. 4 is a block diagram schematically illustrating a printing system including a protection system according to examples herein.

FIG. 5 is a process flow illustrating methods to protect a communication line according to examples herein.

### DETAILED DESCRIPTION

In the following description, numerous details are set forth to provide an understanding of the examples disclosed herein. However, it will be understood that the examples may be practiced without these details. While a limited number of examples have been disclosed, it should be understood that there are numerous modifications and variations therefrom. Similar or equal elements in the Figures may be indicated using the same numeral.

As set forth above, if a communication line is subjected to a short circuit, the integrity of a data generation circuit interfaced by the communication line might be compromised.

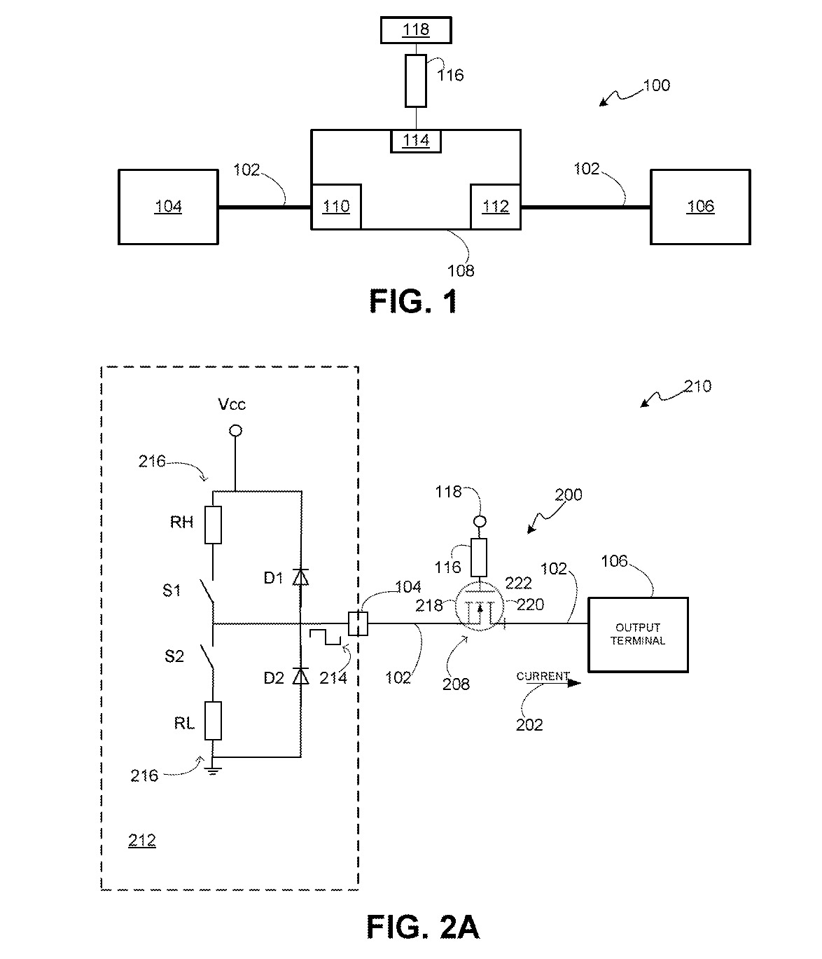

In at least some examples herein, as illustrated by FIG. 1, a system 100 is described for protection of a communication line 102 interfacing an emitter terminal 104 and an output terminal 106. The term “an emitter terminal” as used herein refers to a terminal via which an electrical signal to be transmitted is fed into communication line 102. The term “output terminal” as used herein refers to a terminal via which an electrical signal being transmitted via communication line 102 can be output to an external system. System 100 is mainly composed of three elements: (i) a controllably conductive device 108 connected in series to communication line 102, controllably conductive device 108 having a first main load terminal 110, a second main load terminal 112, and a control input 114 to control resistivity of device 108 via a controllable input; (ii) a control resistor 116 connected to control input 114; and (iii) a reference voltage terminal 118 connected to control input 114 via control resistor 116. In at least some examples herein controllably conductive device 108 includes a field effect transistor (FET) so that first main load terminal 110 corresponds to the FET source, second main load terminal 112 corresponds to the FET drain, and control input 114 corresponds to the FET gate.

In operation of the system, controllably conductive device 108 (a) allows conductance across communication line 102 during normal operation thereof; and (b) turns off communication line 102 when subjected to a short circuit compromising the an emitter circuit connected to the emitter terminal. By turning off communication line 102 it is referred to controllably conductive device 108 imposing a resistivity high enough to sufficiently restrict current across the line and thereby protect circuits connected to the line. For example, for the FET example, controllably conductive device 108 turns off communication line 102 by increasing the resistance of the channel from source to drain.

Further, in system 100 values of the control resistance can be selected for preventing that the controllably conductive device introduces any undesired impedances into the communication line, in particular for high speed signals travelling across it. For example, controllably conductive device 108 may have an internal capacitance. High speed signals travelling across communication line 102 might capacitively couple to control input 114 and thereby undesirably increase impedance across line 102. Control resistance might be selected to be high enough so that the frequency dependent impedance introduced by controllably conductive device 108 does not impair high speed communication across communication line 102.

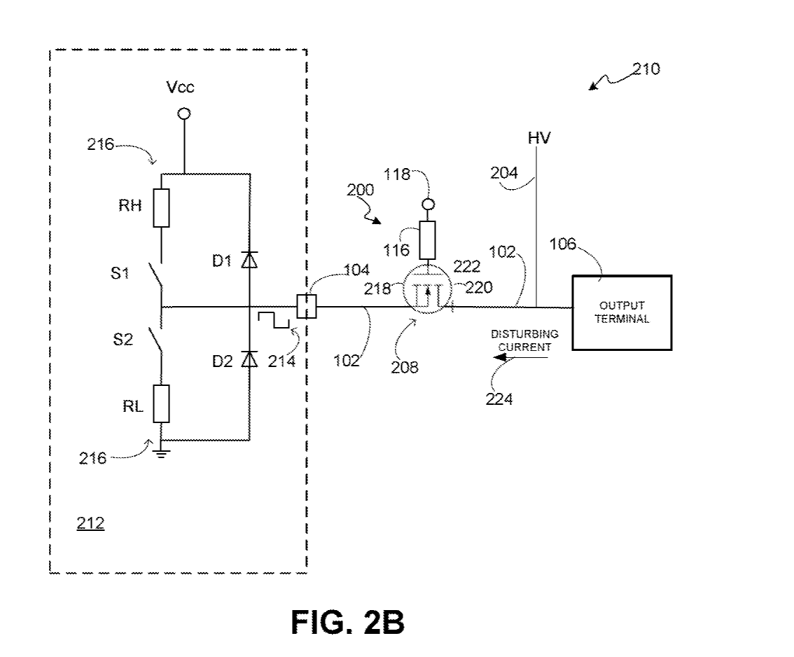

FIGS. 2A and 2B illustrate a system 200 for protection of communication line 102 during operation according to examples. More specifically, FIG. 2A illustrates operation of system 200 during normal operation of communication line 102, and FIG. 2B illustrates operation of system 200 when communication line is subjected to a short circuit 204.

FIGS. 2A and 2B illustrates system 200 implemented in an environment 210. In environment 210, communication line 102 interfaces a transmission circuit 212 with output terminal 106. In the illustrated example, transmission circuit 212 is to generate a digital signal 214 at emitter terminal 104 by turning on and off switches S1 and S2 across generation voltage V_{CC}. Each of switches S1 and S2 are disposed at different ramifications of a voltage divider 216 built by two series resistors R_{H} and R_{L} configured to partition generation voltage generation voltage V_{CC} when both switches S1 and S2 are turned on.

In view of the illustrated configuration of transmission circuit 212, digital signal 214 may be a) high when both switches S1 and S2 are on, b) low when switch S1 is off and switch S2 is on, and c) float when both switches S1 and S2 are off. Transmission circuit 212 is shown to further include clamper diodes D1 and D2 for limiting the voltage generated by voltage divider 216 at emitter terminal 104.

It will be understood that there are other circuit configurations for generating a digital signal at emitter terminal 104. In general, a switch configuration as illustrated in FIGS. 2A and 2B facilitates generation of high speed digital signals. If will be understood that emitter circuit 212 may include further elements not shown in the Figure for the sake of conciseness.

In the illustrated example of FIGs. 2A and 2B, system 200 includes a FET 208, a reference voltage terminal 118, and a control resistor 116. FET 208 is connected in series along communication line 102. More specifically, FET 208 includes a FET source 218, a FET drain 220, and a FET gate 222; FET source 218 is connected to emitter terminal 104; FET drain 220 is connected to the output terminal 106.

In order to set the voltage to control source-gate conductance across FET 208, reference voltage terminal 118 is connected to FET gate 222 via control resistor 116. In at least some examples herein, FET 208 has an internal capacitance (not shown); the combination of control resistor 116 and the FET internal capacitance forms a low pass filter with a cut-off frequency selected to prevents leakage of a high frequency signal via FET gate 222.

FET 208 may be any suitable FET such as a junction FET (JFET) or a metal-oxide-semiconductive FET (MOSFET). FET 208 may be configured as an n-type FET or as a p-type FET. Values of voltage reference to be applied at voltage reference terminal 118 and of values of control resistor 116 are chosen depending on the specific type of the used FET. In the following discussion, it is considered that FET 208 is an n-type transistor.

In the illustrated example, when a gate-to-source voltage V_{GS} is below a threshold for FET 208 to constitute a source-to-drain conductive channel, there is little or no conduction between FET source 218 and FET drain 220 so that emitter terminal 104 and output terminal 106 are disconnected. This is hereinafter referred to as the blocking mode of FET 208. If V_{GS} is above the threshold, FET there is conduction between FET source 218 and FET drain 220 so that digital signal 214 can be transmitted from transmitter pad 104 to output 106 via communication line 102. This is hereinafter referred to as the conductive mode of FET 208.

FIG. 2A depicts normal operation of system 200 in environment 210 for transmission of digital signal 214 via a current 202. There the voltage at emitter terminal 104 is low enough (e.g., 1 to 1.4 Volts for LVDS), in comparison to the voltage at reference voltage terminal 118 (e.g., about 5 to 6 Volts), so that FET 208 is at the conductive mode and does not present a significant impedance that might constraint transmittance of digital signal 214 via communication line 102. This is further facilitated by control resistor 116, which prevents capacitive coupling of digital signal 214 via FET gate 222.

FIG. 2B depicts operation of system 200 in environment 210 when communication line is subjected to short circuit 204 of a high voltage HV (e.g., a voltage higher than 48 Volts). More specifically, short circuit 204 causes that a disturbing current 214 is coupled into communication line 102 and travels towards transmission circuit 212. Disturbing current 214 causes that the voltage at reference voltage terminal 118 starts to increase. Disturbing current 214 may potentially hamper normal operation of transmission circuit 212 or even cause irreparable damage thereto. However, after a certain time and a certain current intensity, disturbing current 214 also causes that the voltage at emitter terminal 104 increases, so that the gate-to-source voltage V_{GS} decreases. At the point at which the V_{GS} decrease is beyond the FET threshold (e.g., when voltage at emitter terminal reaches 3 to 4 Volts, the voltage at reference terminal 118 being 5 to 6 Volts), FET 208 operates in the blocking mode and disturbing current 224 is limited so that voltage at emitter terminal 104 cannot further increase. Thereby, system 200 implements protection of communication line 102 against short circuit 204.

It will be understood that the different components of protection system may be chosen depending on, among other factors, the type of FET 208 and the type of signal being transmitted along communication line 102 (e.g., bandwidth and signal levels). In particular, the values of the voltage at reference terminal 118 and resistor 116 may be chosen in view of these particular parameters. In an example for protection of a LVDS line, a FET of type n is disposed across the communication line connected to a reference voltage of between 3.3 and 5 Volts, and a control resistor is used with a resistance of between 1 and 100 kOhms.

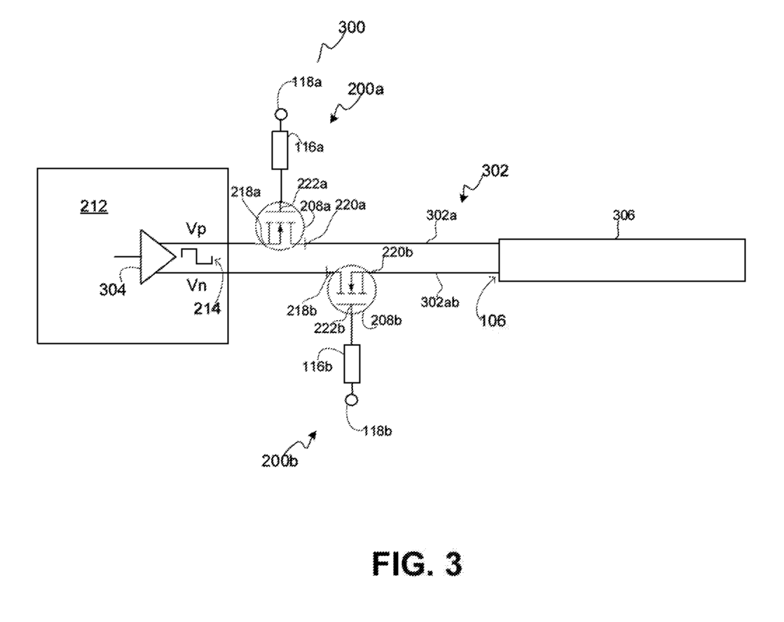

In at least some examples herein, the communication line to be protected is a differential communication line including two connection lines. In such examples, a controllably conductive device is connected as disclosed herein to protect one of the connection lines. A second controllably conductive device is connected as disclosed herein to protect the another one of the connection lines. Such examples are disclosed in the following with reference to FIG. 3.

FIG. 3 illustrates implementation of a protection system 300 according to examples herein for protecting a differential communication line 302. Differential communication line 302 includes two differential communication lines 302a, 302b interfacing transmission circuit 212 and terminal output 106 connecting a differential signal receiving element 306 (e.g., a twisted par cable or a cable). Communication line 302a is to transmit a positive voltage V_P of signal 214. Communication line 302b is to transmit a negative voltage V_N of signal 214. In the illustrated example, signal 214 (and hence voltages V_P and V_N) are generated by a high speed differential driver 304 at transmission circuit 212.

Protection system 300 includes protection sub-systems 300a and 300b to individually protect each of communicating lines 302a, 302b. Protection sub-systems 200a, 200b are respectively shown protecting communication lines 302a, 302b via FETs 208a, 208b. FETs 208a, 208b have FET sources 218a, 218b and FET gates 220a, 220b respectively connected across communication lines 302a, 302b. Reference voltage terminals 118a, 118b are respectively connected to FET gates 222a, 222b via control resistors 116a, 116b. Thereby, protection sub-systems 300a and 300b individually protect communicating lines 302a, 302b against short cuts (not shown in FIG. 3) analogously as protection system 300, illustrated above with respect to FIG. 2.

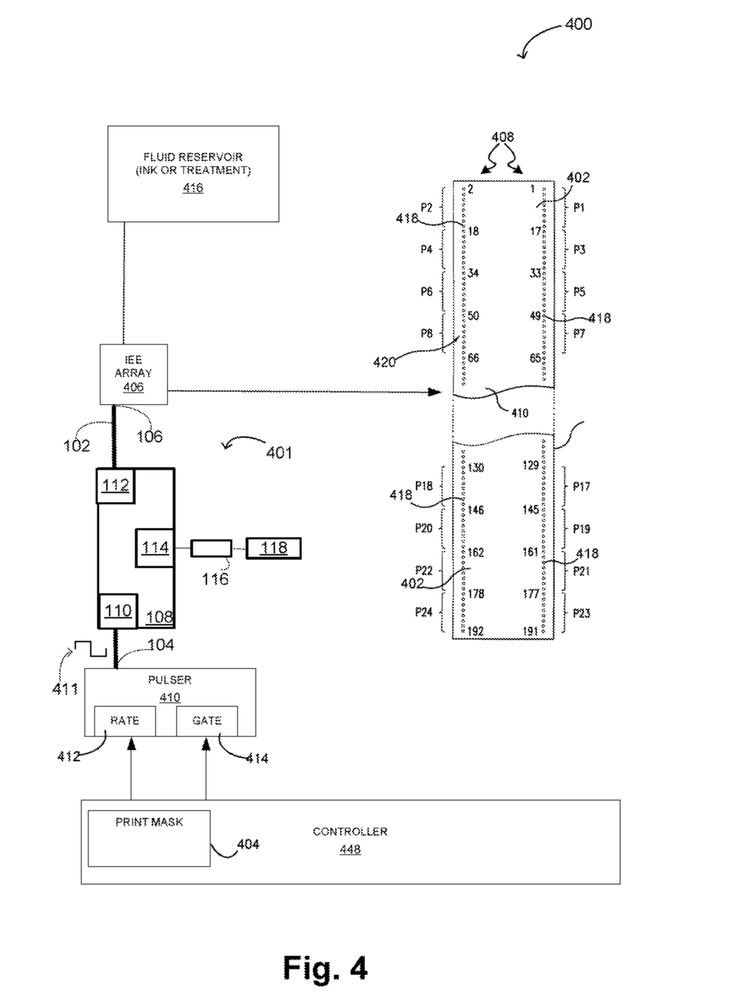

As if will be understood, a protection system may be implemented in different applications involving communication via electrical signals. As set forth above, it might be particularly convenient for applications involving high speed data transmission such as, for example, data transmission higher than 10 Mbyte second. A specific application of protection systems as disclosed herein is to protect a communication line in a printer, since printer operation may require high speed data communication for achieving satisfactory operational time for printing. Moreover, short cut protection as described herein might be in particular desirable for protecting a communication line for transmitting print data to operate a printhead in the printer. Such a communication line may be particularly prone to short cuts since ink might be spilled thereon during printer operation. An example of implementation of protection systems as described herein is set forth in the following with respect to FIG. 4.

FIG. 4 is a block diagram schematically illustrating a printing system 400 comprising a protection system 401 according to examples herein. If will be understood that printing system 400 is merely illustrative and that protection systems according to examples herein may be implemented in other printing systems.

The example is illustrated for a printhead 402 for ejecting a print fluid over a print media. A print fluid may be a colored ink or a transparent ink fluid, such as a treatment fluid for improving print quality (e.g., a fixer fluid or a coater). The depicted elements of printhead 402 are not to scale and are exaggerated for simplification. Printhead 402 includes nozzle array 408 formed by individual nozzles 418. Nozzles 418 may be of any size, number, or pattern. A fluid ejection chamber (not shown) may be located behind nozzles 418 and contains IEEs associated to nozzles 418. A specific group of nozzles (hereinafter referred to as a primitive 420) may be allocated for being fired simultaneously. Nozzle array 408 may be arranged into any number of multiple subsections with each subsection having a particular number of primitives operated by a particular number of IEEs. In the illustrated example, printhead 202 has 192 nozzles with 192 associated filing IEEs; the 192 nozzles (nozzles 1 to 192) are allocated in 24 primitives (primitives P1 to P24) arranged in two columns of 12 primitives each.

The particular fluid ejection mechanism within the printhead may take on a variety of different forms such as those using piezo-electric or thermal printhead technology. For example, if the fluid ejection mechanism is based on a thermal printhead technology, the pulses forwarded to an IEE of IEE array 406 may be forwarded as a current pulse that is applied to a resistor within the particular IEE. The current pulse causes a fluid droplet (not shown), formed with fluid (i.e., ink or treatment fluid) from a fluid reservoir 416 to be ejected from the nozzle associated with the particular IEE.

A print controller 448 may provide a print mask 404 to a pulser 410. Print mask 404 defines how nozzles in printhead 402 are to be operated in order to complete a specific print job. In the illustrated examples, pulser 410 is located off of printhead 202 and is interfaced with printhead 402 via communication line 102. More specifically, communication line 102 interfaces an emitter terminal 104 as pulser 410 and an output terminal at an ink ejection element (IEE) array 406 of printhead 102. Printer 400 may include further communication lines interlacing pulser 410 and IEE array 106 being protected analogously as illustrated. For example, a communication line might be included for each IEE in the array.

Pulser 410 may process data from print mask 404 to generate pulses that control an IEE array 406 associated to nozzle array 418. IEE array 206 includes IEEs (not shown) operatively coupled to nozzles 418 of printhead 402. In the illustrated example, controller 448 provides firing data to pulser 410 on two lines: i) a rate line 412 for setting the pulse rate; and ii) a gate line 414 for setting which pulses are to be forwarded to a particular IEE. Based on the firing data, pulser 410 can generate print data 411 to operate printhead 402

Since communication line 102 is in the proximity of printhead 408, the risk of short cut caused by ink being spilled thereon might be particularly high. Therefore, a protection system 401 is provided across communication line 102 in printer 400. Protection system 410 is constituted analogously as illustrated above with respect to FIG. 1. More specifically, it includes a controllably conductive device 108 (e.g., a FET). Main terminals 110, 112 (e.g., a FET source and a FET drain) establish a link in communication line 102. Conductance of the link is controllable via a voltage reference terminal 118 connected to a control input 114 of device 108 via a control resistor 116. Thereby, if a too high voltage is applied onto communication line 102 (e.g., via a shortcut), controllably conductive device 108 protects pulser 410 by turning off communication line 102 by increasing impedance between main terminals 110, 112. Reference resistor 116 facilitates that the link formed by controllably conductive device 108 does not compromise communication speed via capacitive coupling.

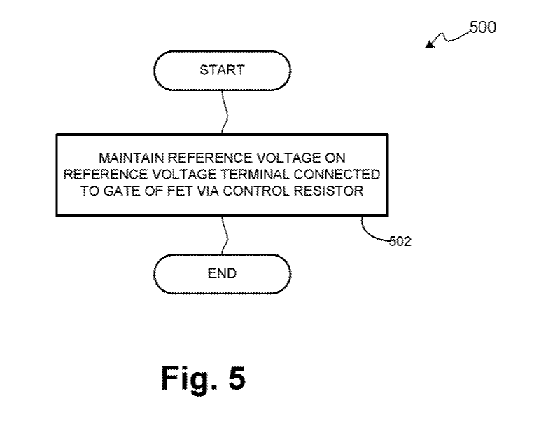

FIG. 5 shows a process flow 500 illustrating methods to protect a communication line interfacing a first pad and a second pad according to examples herein. The communication line may be, for example, any of the communication lines illustrated above with respect to FIGS. 1 to 4. The first pad may be, for example, any of the emitting terminals illustrated above with respect to FIGS. 1 to 4. The second pad may be, for example, any of the output terminals illustrated above with respect to FIGS. 1 to 4.

At block 502, a reference voltage is maintained on a reference voltage terminal (e.g., terminal 118 illustrated above with respect to FIGS. 1 to 4) connected to the gate of a FET (e.g., FET 208 illustrated above with respect to FIGS. 1 to 4) via a control resistor (e.g., resistor 116 illustrated above with respect to FIGS. 1 to 4). The FET is connected in series along the communication line. The FET source is connected to the first pad. The FET chain is connected to the second pad. The reference voltage terminal is connected to the transistor gate via a control resistor. Thereby the FET is operated to (a) allow conductance across the FET during operation of the communication line at a selected voltage range: and (b) turn off the communication line when the voltage across the communication line exceeds a selected voltage range.

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations. Further, flow charts herein illustrate specific block orders; however, if will be understood that the order of execution may differ from that which is depicted. For example, the order of execution of two or more blocks may be scrambled relative to the order shown. Also, two or more blocks shown in succession may be executed concurrently or with partial concurrence. Further, claims reciting “a” or “an” with respect to a particular element contemplate incorporation of one or more such elements, neither requiring nor excluding two or more such elements. Further, at least the terms “include” and “comprise” are used as open-ended transitions.

What is claimed is:

1. A system for protection of a communication line interfacing an emitter terminal and an output terminal, the system comprising:
a controllably conductive device having a first main load teiminal, a second main load terminal, and a control input, the controllahiy conductive device being connected in series along the communication line, the first main load being connected to the emitter terminal, the second main load being connected to the output terminal;
a reference voltage terminal connected to the control input via a control resistor.
whereby, in operation of the system, the controllably conductive device (a) allows conductance across the communication line during normal operation of the communication line; and (b) turns off the communication line when subjected to a short circuit compromising the an emitter circuit connected to the emitter terminal.

2. The system of claim 1, wherein the controllably conductive device includes a field effect transistor (FET) connected in series along the communication line, the FET source being connected to the emitter terminal, the FET drain being connected to the output terminal; and the reference voltage terminal connected to the FET gate via the control resistor.

3. The system of claim 2, wherein the FET is a MOSFET.

4. The system of claim 2, wherein the FET is an n-type FET.

5. The system of claim 2, wherein the FET has an internal capacitance, the combination of the control resistor and the internal capacitance forming a low pass filter to prevent leakage of a high frequency signal via the FET gate.

6. The system of claim 1, wherein the resistor has a resistance between 1 k and 100 kOhmns.

7. The system of claim 1, wherein the communication line is a differential communication line including to connection lines, the controllably conductive device connected to protect one of the connection lines, a second controllably conductive device being connected to protect the another one of the connection lines.

8. The system of claim 1, wherein the emitter terminal is connected to a transmission circuit including a switch, a series resistor and a clamping diode.

9. A printer, comprising;
a communication line interfacing an emitter circuit pad and a receiving terminal;
a field effect transistor (FET) connected in series along the communication line,
a source of the FET being connected to the communication output,
a drain of the FET being connected to the printhead terminal; and
a reference voltage terminal to set connected to a gate of the FET via a control resistor.

10. The printer of claim 9, wherein the receiving terminal is at a printhead.

11. The printer of claim 9, wherein emitter circuit pad is to transmit print data to operate the printhead.

12. The printer of claim 1, wherein the transmission circuit is a LVDS transmission system.

13. A method to protect a communication line interfacing a first pad and a second pad, the method comprising:
maintaining a reference voltage on a reference voltage terminal connected to a gate of a field effect transistor (FET) via a control resistor,
the FET being connected in series along the communication line,
a source of the FET being connected to the first pad; and
a drain of the FET being connected to the second pad,
whereby the FET is operated to (a) allow conductance across the FET during operation of the communication line at a selected voltage range: and (b) turn off the communication line when the voltage across the communication line exceeds a selected voltage range.

14. The method of claim 13, wherein the reference is between 3.3 Volts and 5 Volts.

15. The method of claim 13, wherein the communication line transmits information with at least 10 MByte/second.
